(19) United States
(12) Patent Application Publication
(10) Pub. No.: US 2010/0092772 A1
(43) Pub. Date: Apr. 15, 2010

(54) PRESSURE-SENSITIVE ADHESIVE SHEET

(75) Inventors: Takuo Nishida, Saitama (JP); Akihito Yamada, Saitama (JP); Sou Miyata, Chiba (JP); Takuya Tetsumoto, Saitama (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: LINTEC CORPORATION, Tokyo (JP)

(21) Appl. No.: 12/598,831

(22) PCT Filed: Jan. 8, 2008
(86) PCT No.: PCT/JP08/50056

§ 371 Date: Nov. 4, 2009

(30) Foreign Application Priority Data
May 7, 2007 (JP) 2007-122570

(51) Int. Cl. C09J 7/02; B32B 33/00

(52) U.S. Cl. 428/345; 428/352

(57) ABSTRACT

The pressure sensitive adhesive sheet of the present invention is characterized by a pressure sensitive adhesive sheet in which a pressure sensitive adhesive layer is formed on at least one surface of a base material and in which a surface of the above pressure sensitive adhesive layer at a side opposite to the base material is brought into contact with a release agent layer, wherein the pressure sensitive adhesive layer and the release agent layer do not substantially contain a silicone-based compound, and the pressure sensitive adhesive layer contains an antioxidant. It has a good releasing performance from the release agent layer and is excellent in a releasing stability after ageing.

### TECHNICAL FIELD

The present invention relates to a pressure sensitive adhesive sheet, more specifically to a pressure sensitive adhesive sheet which is a non silicone-based one and has a good releasing performance between a release agent layer and a pressure sensitive adhesive layer and which is excellent in releasing stability after ageing and suitably used for applications related particularly to precision electronic devices.

### TECHNICAL BACKGROUND

In recent years, various forms of pressure sensitive adhesive sheets are used in various stages in production processes for precision electronic devices such as ceramic condensers, hard disk drives, semiconductor apparatuses and the like.

In the above pressure sensitive adhesive sheets used in the production processes for precision electronic devices, silicone-based pressure sensitive adhesives are likely to bring about troubles in the electronic devices due to silicone-based compounds of a low molecular weight which are contained in the above pressure sensitive adhesives.

Accordingly, there are usually used non silicone-based pressure sensitive adhesives such as acrylic-based pressure sensitive adhesives, polyester-based pressure sensitive adhesives, urethane-based pressure sensitive adhesives. In general, available as pressure sensitive adhesive sheets are not only pressure sensitive adhesive sheets used in production processes for precision electronic devices but also those of a type in which a release sheet comprising a release agent layer provided on a base material is stuck in order to protect a pressure sensitive adhesive layer after production until use, those of a type in which a release agent layer is provided on a surface of a base material at a side opposite to a pressure sensitive adhesive layer on the base material and in which it is wound in a continuous roll form and those of a type in which a release agent layer is similarly provided on a surface of a base material at a side opposite to a pressure sensitive adhesive layer on the base material and in which a plurality of sheets obtained by cutting it to a fixed size are laminated.

In pressure sensitive adhesive sheets used for general uses other than uses for precision electronic devices, silicone-based compounds are often used for a release agent layer in all of the types described above. When the silicone-based compounds are used for applications related to precision electronic devices, silicone-based compounds of a low molecular weight which are contained in a release agent layer are transferred to the pressure sensitive adhesive layer and remain therein, and troubles are likely to be brought about in the electronic devices as is the case with the silicone-based pressure sensitive adhesives described above.

Accordingly, alkyd-based resins (refer to, for example, Patent document 1) and long chain alkyl-based resins (refer to, for example, Patent document 2) which are known as non silicone-based release agents are tried to be used for a release agent layer in pressure sensitive adhesive sheets used for applications in precision electronic devices.

However, when the above resins are used in order to form a release agent layer, brought about is the problem that a releasing force between a pressure sensitive adhesive layer and a release agent layer is high to make it difficult in a certain case to release the pressure sensitive adhesive layer from the release agent layer.

Under such circumstances, proposed are pressure sensitive adhesive sheets which are a non silicone-based one and excellent in a releasing property between a release agent layer and a pressure sensitive adhesive layer, a releasing stability after ageing and an adhesive property between a pressure sensitive adhesive layer and a base material (refer to, for example, Patent documents 3 and 4). Incidentally, in both cases of the Patent documents 3 and 4, release sheets having a release agent layer formed from a release agent which comprises 1,4-polybutadiene as a principal component and which is mixed with an antioxidant are used, whereby a releasing stability after ageing is achieved.

However, even when the above release sheets are used, a releasing force between a pressure sensitive adhesive layer and a release agent layer grows large (heavy releasing) when the sheets are subjected to thermal history in a state in which the pressure sensitive adhesive layer and the release agent layer are stuck thereon, and they are not satisfactory in terms of a releasing stability after ageing.

In pressure sensitive adhesive sheets used for applications in precision electronic devices, pressure sensitive adhesive sheets in which an antioxidant is added to an acrylic-based or silicone-based pressure sensitive adhesive layer are disclosed (refer to, for example, Patent document 5). In the above document, however, a silicone-based compound which is not a non silicone-based (co)polymer such as a diene-based (co)polymer is used in a releasing (releasing from adhesive layer) agent layer, and they do not have an object to improve a releasing stability after ageing.

Patent document 1: JP 1982-49685 A
Patent document 2: JP 2002-249757 A
Patent document 3: JP 2005-199586 A
Patent document 4: JP 2005-205813 A

Patent document 5: JP 2006-77072 A

### DISCLOSURE OF THE INVENTION

### Problem to be Solved by the Invention

The present invention has been made under the circumstances described hereinabove, and an object thereof is to provide a pressure sensitive adhesive sheet which is excellent in a releasing stability after ageing between a release agent layer and a pressure sensitive adhesive layer after subjected to thermal history even if the release agent layer comprises a non silicone-based resin such as a diene-based (co)polymer. Intensive researches repeated by the present inventors in order to achieve the object described above have resulted in findings that the object can be achieved by a pressure sensitive adhesive sheet in which a pressure sensitive adhesive layer is formed on a base material and in which a surface of the above pressure sensitive adhesive layer is brought into contact with a release agent layer comprising a non silicone-based resin such as a diene-based (co)polymer and an ethylene propylene copolymer, wherein the pressure sensitive adhesive layer contains an antioxidant. The present invention has been completed based on the above findings.

### Means for Solving the Problem

That is, the present invention provides:

(1) A pressure sensitive adhesive sheet in which a pressure sensitive adhesive layer is formed on at least one surface of a base material and in which a side opposite of a surface of the above pressure sensitive adhesive layer to the base material is brought into contact with a release agent layer, wherein the pressure sensitive adhesive layer and the release agent layer do not substantially contain a silicone-based compound, and the pressure sensitive adhesive layer contains an antioxidant,
(2) The pressure sensitive adhesive sheet according to the above item (1), wherein the release agent layer comprises a rubber-based elastomer,
(3) The pressure sensitive adhesive sheet according to the above item (2), wherein the rubber-based elastomer is at least one selected from the group consisting of a diene-based homopolymer, a diene-based copolymer and an ethylene propylene copolymer,
(4) The pressure sensitive adhesive sheet according to the above item (3), wherein the diene-based homopolymer is a polybutadiene rubber or a polyisoprene rubber,
(5) the pressure sensitive adhesive sheet according to the above item (3), wherein the diene-based copolymer is a styrene-butadiene copolymer,
(6) The pressure sensitive adhesive sheet according to the above item (4), wherein the polybutadiene rubber is 1,4-polybutadiene,
(7) The pressure sensitive adhesive sheet according to any one of the above items (1) to (6), wherein the pressure sensitive adhesive layer is a layer comprising an acrylic pressure sensitive adhesive,
(8) The pressure sensitive adhesive sheet according to any one of the above items (1) to (6), wherein the release agent layer is a layer formed on at least one surface of a base material for release sheet,
(9) The pressure sensitive adhesive sheet according to any one of the above items (1) to (6), wherein an undercoat layer is provided between the base material and the release agent layer or between the base material for release sheet and the release agent layer,
(10) The pressure sensitive adhesive sheet according to the above item (9), wherein the undercoat layer comprises a polyurethane elastomer,
(11) The pressure sensitive adhesive sheet according to any one of the above items (1) to (6), wherein the release agent layer is a layer containing an antioxidant and
(12) the pressure sensitive adhesive sheet according to any one of the above items (1) to (6), wherein the release agent layer is a layer crosslinked by irradiating with an ultraviolet ray.

### EFFECT BY THE INVENTION

In the pressure sensitive adhesive sheet of the present invention, both of the pressure sensitive adhesive layer and the release agent layer do not substantially contain a silicone-based compound, and a releasing force between the release agent layer and the pressure sensitive adhesive layer does not grow large even after thermal history. That is, the pressure sensitive adhesive sheet is not provided with heavy releasing and is excellent in a releasing stability after ageing.

### BRIEF DESCRIPTION OF THE DRAWINGS

FIG. 1 is a schematic drawing of a cross section showing a layer constitution in one embodiment of the pressure sensitive adhesive sheet of the present invention.

FIG. 2 is a schematic drawing of a cross section showing a layer constitution in another embodiment of the pressure sensitive adhesive sheet of the present invention.

### BEST MODE FOR CARRYING OUT THE INVENTION

The pressure sensitive adhesive sheet of the present invention is characterized in that a pressure sensitive adhesive layer is formed on at least one surface of a base material; a surface of the above pressure sensitive adhesive layer at a side opposite to the base material is brought into contact with a release agent layer; the pressure sensitive adhesive layer and the release agent layer do not substantially contain a silicone-based compound; and the pressure sensitive adhesive layer contains an antioxidant.

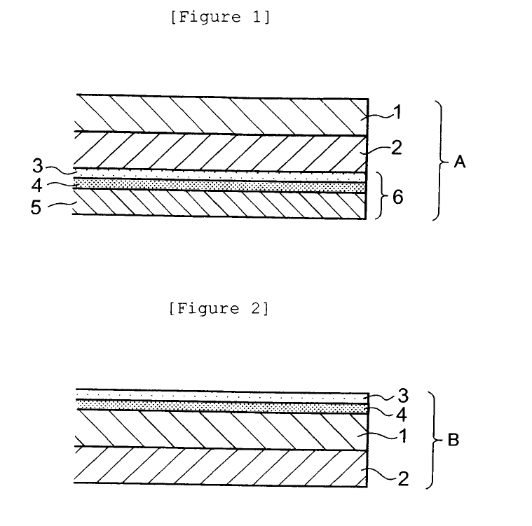

Hereinafter, the pressure sensitive adhesive sheet of the present invention is explained in detail with reference to FIG. 1 and FIG. 2.

A pressure sensitive adhesive sheet A shown in FIG. 1 is one of the embodiments of the pressure sensitive adhesive sheet according to the present invention in which a pressure sensitive adhesive layer 2 is provided on one surface of a base material 1 and in which a release sheet 6 comprising an undercoat layer 4 (optional) and a release agent layer 3 each provided on one surface of a base material 5 for release sheet is laminated thereon.

A pressure sensitive adhesive sheet B shown in FIG. 2 is one of different embodiments of the pressure sensitive adhesive sheet according to the present invention in which a pressure sensitive adhesive layer 2 is provided on one surface of a base material 1 as is the case with the pressure sensitive adhesive sheet A shown in FIG. 1 and in which a constitution of a layer is different in that an undercoat layer 4 (optional) and a release agent layer 3 are provided on a surface of the base material 1 at a side opposite to the pressure sensitive adhesive layer 2.

Further, though not illustrated in the drawing, the present invention includes, as one of the embodiments, a pressure sensitive adhesive sheet of a double-faced tape type comprising a laminated sheet in which a pressure sensitive adhesive layer 2, a release agent layer 3, an undercoat layer (optional) and a base material 5 for release sheet are provided as well in order on the other surface of the base material 1 in FIG. 1. In the above case, the release sheet 6 may be laminated only on one surface. In such case, however, a state in which the release agent layer 3 is formed on both surfaces of the base material 5 for release sheet has to be assumed. When only one release sheet 6 is used in the above pressure sensitive adhesive sheet of a so-called double-faced tape type, the laminated sheet assumes a product form in which it is wound in a continuous roll shape or a product form of a laminated sheet comprising plural pressure sensitive adhesive sheets cut to a prescribed size (the same in the case of the pressure sensitive adhesive sheet B shown in FIG. 2).

In the present invention, the same effect is exerted by the antioxidant contained in the pressure sensitive adhesive layer 2 regardless of the embodiments of the pressure sensitive adhesive sheets shown in FIG. 1 and FIG. 2 and the pressure sensitive adhesive sheet of a double-faced tape type, and therefore the pressure sensitive adhesive sheet is explained based on the pressure sensitive adhesive sheet shown in FIG. 1 in the following explanations.

In the present invention, the base material 1 (hereinafter referred to merely as the base material) is not specifically restricted, and capable of being used are publicly known plastic-made film base materials, paper base materials such as glassine paper, coated paper, cast coated paper, lint-free paper and the like, laminated papers obtained by laminating the above paper base materials with thermoplastic resins such as polyethylene and the like, synthetic papers having voids in an inside and the like. The paper base materials are preferably used from the viewpoint of exerting clearly the effects provided by the pressure sensitive adhesive sheet of the present invention.

The film base material is not specifically restricted and includes films or sheets produced from polyolefin-based resins such as polyethylene resins, polypropylene resins and the like, polyester-based resins such as polybutylene terephthalate resins, polyethylene terephthalate (PET) resins and the like, acetate-based resins, polyamide-based resins, polyimide-based resins, ABS-based resins, polystyrene-based resins, vinyl chloride-based resins and the like and laminated films comprising the above resins. In particular, films or sheets produced from polyester-based resins such as PET have a good heat resistance and are excellent in a mechanical strength and relatively inexpensive in a cost, and therefore they are used in many cases for products including various electronic parts and precision products which are applications for the pressure sensitive adhesive sheet of the present invention. They are suitably used as well in the present invention.

The base material may be non-oriented or oriented vertically or laterally in a monoaxial direction or a biaxial direction. A thickness of the base material is not specifically restricted and is usually 5 to 200 μm, preferably 25 to 150 μm. The strength and the rigidity which are required in producing and using the pressure sensitive adhesive sheet are secured by controlling the thickness to 5 μm or more, and controlling it to 200 μm or less prevents the strength and the rigidity from growing higher than necessary and the product from being bulky and makes it possible to prevent the cost from going up.

The base material may be colored or colorless and transparent. Further, printing and writing may be provided on a surface or a back side of the base material. In order to meet it, a thermosensitive recording layer, a print image reception layer in which thermal transfer, ink jet, laser printing and the like can be carried out, a printability improving layer and the like may be provided on the base material.

In the present invention, when the film base material not the paper base material is used as the base material, it can usually be subjected, if desired, to physical or chemical surface treatment by an oxidation method, a roughening method and the like for the purpose of enhancing an adhesion with the pressure sensitive adhesive layer provided thereon. The oxidation method described above includes, for example, corona discharge treatment, chromic acid treatment, flame treatment, hot blast treatment, ozone•exposure treatment, ultraviolet ray irradiation treatment and the like, and the roughening method includes, for example, a sand blast method, a solvent treating method and the like. The above surface treatments are suitably selected according to the kind of the film base material, and usually a corona discharge treatment method is preferably used in terms of an effect and a handing property.

In the pressure sensitive adhesive sheet of the present invention, the pressure sensitive adhesive layer is provided on at least one surface of the base material described hereinabove. A pressure sensitive adhesive used for forming the pressure sensitive adhesive layer described hereinabove is not specifically restricted, and optional pressure sensitive adhesives suitably selected from pressure sensitive adhesives which have so far conventional been used as pressure sensitive adhesives for pressure sensitive adhesive sheets can be used. For example, acrylic-based pressure sensitive adhesives, rubber-based pressure sensitive adhesives, polyurethane-based pressure sensitive adhesives and polyester-based pressure sensitive adhesives can be use, and among them, the acrylic-based pressure sensitive adhesives are usually used well. In the pressure sensitive adhesive sheet of the present invention, the pressure sensitive adhesive layer does not substantially contain a silicone-based compound, and therefore a silicone-based pressure sensitive adhesive is not used.

Pressure sensitive adhesives containing at least one selected from (meth)acrylic ester homopolymers, copolymers containing two or more units of (meth)acrylic esters and copolymers of (meth)acrylic esters with other functional monomers are used as the acrylic-based pressure sensitive adhesives described above. The above (meth)acrylic esters include, for example, methyl (meth)acrylate, ethyl (meth)acrylate, butyl (meth)acrylate, pentyl (meth)acrylate, hexyl (meth)acrylate, 2-ethylhexyl (meth)acrylate, heptyl (meth)acrylate, octyl (meth)acrylate, nonyl (meth)acrylate, decyl (meth)acrylate and the like. The functional monomers include, for example, hydroxyl group-containing monomers such as hydroxyethyl (meth)acrylate, hydroxypropyl (meth)acrylate and the like, amide group-containing monomers such as (meth)acrylamide, dimethyl(meth)acrylamide and the like and carboxylic acid group-containing monomers such as (meth)acrylic acid and the like.

The pressure sensitive adhesive sheet of the present invention contains an antioxidant as an essential component in the pressure sensitive adhesive layer.

The antioxidant is not specifically restricted, and any one of publicly known phosphite-based antioxidants, organic sulfur-based antioxidants, hindered phenol-based antioxidants, vitamin-based antioxidants and the like can be used.

The phosphite-based antioxidants include, for example, compounds having a phosphite skeleton in a chemical structural formula thereof, to be specific, Irgafos 38, Irgafos 168, Irgafos P-EPQ and Irgafos 126 (manufactured by Ciba Specialty Chemicals K.K.), Sumilizer TNP, Sumilizer TPP-P and Sumilizer P-16 (manufactured by Sumitomo Chemical Co., Ltd.), ADK STAB PEP-4C, ADK STAB PEP-8, ADK STAB 11C, ADK STAB PEP-36, ADK STAB HP-11, ADK STAB 260, ADK STAB 522A, ADK STAB 329K, ADK STAB 1500, ADK STAB C, ADK STAB 135A and ADK STAB 3010 (manufactured by ADEA CORPORATION) and the like.

The organic sulfur-based antioxidants include, for example, compounds having a thioether skeleton in a chemical structural formula thereof, to be specific, Irganox PS800FL and Irganox PS802FL (manufactured by Ciba Specialty Chemicals K.K.), Sumilizer TP-M, Sumilizer TP-D, Sumilizer TL and Sumilizer MB (manufactured by Sumitomo Chemical Co., Ltd.), ADK STAB AO-23 (manufactured by ADEKA CORPORATION) and the like.

The hindered phenol-based antioxidants include, for example, compounds having a 2,6-alkylphenol skeleton in a chemical structural formula thereof, to be specific, Irganox 245, Irganox 259, Irganox 565, Irganox 1010, Irganox 1035, Irganox 1076, Irganox 1098, Irganox 1222, Irganox 1330, Irganox 1425, Irganox 3114, Irganox 1520, Irganox 1135, Irganox 1141 and Irganox HP2251 (manufactured by Ciba Specialty Chemicals K.K.), Sumilizer BHT, Sumilizer MDP-S, Sumilizer GA-80, Sumilizer BBM-S, Sumilizer WX-R, Sumilizer GM and Sumilizer GS (manufactured by Sumitomo Chemical Co., Ltd.), ADK STAB AO-30 (manufactured by ADEKA CORPORATION) and the like. Further, a vitamin E-based antioxidant such as Irganox E201 (manufactured by Ciba Specialty Chemicals K.K.) can be used as well.

The above antioxidants may be used alone or in combination of two or more kinds thereof. A use amount thereof is preferably 0.01 part by mass or more based on 100 parts by mass of the solid matters contained in the pressure sensitive adhesive from the viewpoint of inhibiting heavy releasing caused by degradation of a rubber-based elastomer such as a diene-based (co)polymer, an ethylene propylene copolymer and the like contained in the release agent layer, and usually it is preferably 10 parts by mass or less based on 100 parts by mass of the solid matters contained in the pressure sensitive adhesive from the viewpoint of having to maintain a pressure sensitive adhesive characteristic of the pressure sensitive adhesive sheet. The amount falls in a range of more preferably 0.05 to 5 parts by mass.

Also, an isocyanate-based cross-linking agent, an epoxy-based cross-linking agent, an aziridine-based cross-linking agent and a chelate-based cross-linking agent can be used, if necessary, for the pressure sensitive adhesive in the pressure sensitive adhesive sheet of the present invention. In the isocyanate-based cross-linking agent, used are tolylenediisocyanate (TDI), hexamethylenediisocyanate (HMDI), isophoronediisocyanate (IPDI), xylylenediisocyanate (XDI), hydrogenated tolylenediisocyanate, diphenylmethanediisocyanate, trimethylolpropane-modified TDI and the like. In the epoxy-based cross-linking agent, used are ethylene glycol glycidyl ether, 1,6-hexanediol glycidyl ether, trimethylolpropane diglycidyl ether, diglycidylaniline, diglycidylamine and the like. In the aziridine-based cross-linking agent, used are 2,2-bishydroxymethylbutanol-tris[3-(1-aziridinyl)propionate], 4,4-bis(ethyeleneiminocarboxyamino)-diphenylmethane, tris-2,4,6-(1-aziridinyl)-1,3,5-triazine, tris[1-(2-methyl)aziridinyl]phosphine oxide, hexa[1-(2-methyl)-aziridinyl]triphosphatriazine and the like. In the chelate-based cross-linking agent, aluminum chelate, titanium chelate and the like are used. Required physical properties in the pressure sensitive adhesive can be exerted to various adherends by suitably controlling an amount of the cross-linking agent.

An amount of the cross-linking agent is usually 0.01 to 10 parts by mass, preferably 0.05 to 5 parts by mass based on 100 parts by mass of the solid matters contained in the pressure sensitive adhesive.

The pressure sensitive adhesive may be used not only alone but also, if necessary, in combination of two or more kinds thereof.

The pressure sensitive adhesive for forming the pressure sensitive adhesive layer described above can contain, if necessary, additives contained usually in pressure sensitive adhesives for pressure sensitive adhesive sheets, for example, a tackifier, an ultraviolet ray absorber, a colorant, an antistatic agent and the like.

In respect to a method for forming the pressure sensitive adhesive layer, a pressure sensitive adhesive solution may be coated on a release agent layer of a release sheet base material described later and dried to form a pressure sensitive adhesive layer, and then it may be stuck to a base material, or a pressure sensitive adhesive layer may be formed on one surface of a base material, and then it may be stuck to a release agent layer of a release sheet base material. In order to obtain the construction of the pressure sensitive adhesive sheet B shown in FIG. 2, a release agent layer described later is formed on one surface of the base material, and then a pressure sensitive adhesive layer is formed on a surface thereof to wind it in a roll form, whereby the above sheet can be produced. A solvent suitably selected from publicly known solvents having a good solubility to the pressure sensitive adhesive can be used as the organic solvent used for preparing the pressure sensitive adhesive solution. The above organic solvent includes, for example, toluene, xylene, methanol, ethanol, isobutanol, n-butanol, acetone, methyl ethyl ketone, tetrahydrofuran and the like. They may be used alone or in combination of two or more kinds thereof.

The pressure sensitive adhesive solution can be coated by a coating method which has so far been publicly known, such as a bar coating method, a reverse roll coating method, a knife coating method, a roll knife coating method, a gravure coating method, an air doctor coating method, a doctor blade coating method and the like.

A thickness of the pressure sensitive adhesive layer falls in a range of usually 5 to 100 μm, preferably 10 to 60 μm. Controlling the thickness to 5 μm or more secures the required strength in the pressure sensitive adhesive, and controlling it to 100 μm or less prevents the pressure sensitive adhesive from protruding from an end of the pressure sensitive adhesive sheet and the product from being bulky and restrains the cost from going up.

Subsequently, the release sheet is explained. The release sheet base material in the release sheet is not specifically restricted, and there can be used base materials suitably selected from publicly known release sheet base materials which have so far been known as release sheet base materials.

Capable of being used as the above base material are paper base materials such as glassine paper, coated paper, cast coated paper, lint-free paper and the like, laminated papers obtained by laminating the above paper base materials with thermoplastic resins such as polyethylene and the like, synthetic papers having voids in an inside and the like. A film base material is preferably used from the viewpoint of exerting clearly the effects provided by the pressure sensitive adhesive sheet of the present invention.

The film base material is not specifically restricted and includes films or sheets produced from polyolefin-based resins such as polymethylpentene resins, polypropylene resins and the like, polyester-based resins such as polybutylene terephthalate resins, polyethylene terephthalate (PET) resins and the like, acetate-based resins, polyamide-based resins, polyimide-based resins, polycarbonate-based resins, cellulose acetate-based resins and the like and laminated films including the above resins. In particular, films or sheets produced from polyester-based resins such as PET have a good heat resistance and are excellent in a mechanical strength and relatively inexpensive in a cost, and therefore they are used in many cases for products including various electronic parts and precision products which are applications for the pressure sensitive adhesive sheet of the present invention. They are suitably used as well in the present invention.

A thickness of the above release sheet base material is not specifically restricted and is usually 5 to 200 μm, preferably 20 to 150 μm.

It is to be noted that in the pressure sensitive adhesive sheet of the present invention, the base material 1 in FIG. 2 plays as well a role of the release sheet base material in the case of the pressure sensitive adhesive sheet B shown in FIG. 2 and the pressure sensitive adhesive sheet of a double-faced tape type.

When a plastic film is used as the release sheet base material, a surface of the above plastic film at a side where a release agent layer is provided can usually be subjected, if desired, to physical or chemical surface treatment by an oxidation method, a roughening method and the like for the purpose of enhancing a pressure sensitive adhesive property between the plastic film and the release agent layer. The oxidation method described above includes, for example, corona discharge treatment, chromic acid treatment, flame treatment, hot blast treatment, ozone or ultraviolet ray irradiation treatment and the like, and the roughening method includes, for example, a sand blast method, a solvent treating method and the like. The above surface treatments are suitably selected according to the kind of the base material, and usually a corona discharge treatment method is preferably used in terms of an effect and handling. Further, a primer treatment can be carried out as well.

The release agent used for forming the release agent layer includes long chain alkyl-based resins, alkyd-based resins, polyolefin-based resins, rubber-based elastomers and the like, and the rubber-based elastomers are suitably used. The rubber-based elastomers include diene-based homopolymers such as polybutadiene rubbers, polyisoprene rubbers, polychloroprene rubbers and the like, diene-based copolymers such as styrene-butadiene copolymers, styrene-isoprene copolymers and the like, ethylene-propylene copolymers such as ethylene propylene diene elastomers (EPDM), ethylene-propylene rubbers (EPR) and the like, butyl rubbers, fluorinated rubbers and the like.

Among the rubber-based elastomers described above, the diene-based homopolymers such as polybutadiene rubbers, polyisoprene rubbers and the like are preferred. More specifically, 1,4-polybutadiene is preferred, and this is polybutadiene which is constituted only from a 1,4-bond excluding a 1,2-bond unavoidably produced in polymerization. 1,4-polybutadiene may assume either of a cis structure and a trans structure, and 1,4-polybutadiene having an optional content of a cis structure can be used.

The release agent layer in the release sheet can be formed by dissolving the rubber-based elastomer described above in an organic solvent to prepare a release agent solution, coating the above solution on a release sheet base material and heating it at a temperature of approximate 40 to 160° C. for a time of approximate 30 seconds to 1 minute to evaporate the organic solvent and further irradiating it, if necessary, with an active energy beam such as an ultraviolet ray and the like to crosslink the rubber-based elastomer.

An ultraviolet ray and an electron beam are representative as the active energy beam, and in the case of irradiating with, for example, an ultraviolet ray, a high pressure mercury lamp, a metal halide lamp, a high power metal halide lamp, an electrodeless lamp and the like which have so far been publicly known can be used as the ultraviolet ray lamp, and the electrodeless lamp is most suited in terms of a crosslinking property of the rubber-based elastomer. In the case of irradiation with an ultraviolet ray, an irradiation dose thereof is preferably 10 mJ/cm² or more and preferably 1000 mJ/cm² or less from the viewpoint of obtaining a high adhesion between the release sheet base material and the release agent layer. An irradiation dose of an ultraviolet ray falls in a range of further preferably 70 to 500 mJ/cm², particularly preferably 100 to 300 mJ/cm².

In the case of crosslinking the rubber-based elastomer by irradiation with an ultraviolet ray, use of a photosensitizer added to the release agent solution makes it possible to carry out the crosslinking more efficiently.

The specific examples of the photosensitizer include aromatic ketones such as benzophenone, p,p′-dimethoxybenzophenone, p,p′-dichlorobenzophenone, p,p′-dimethylbenzophenone, acetophenone, acetonaphthone and the like, and they provide good results. In addition thereto, aromatic aldehydes such as terephtalaldehyde and the like and quinone-based aromatic compounds such as methylanthraquinone and the like can be used as well.

An addition amount of the photosensitizer is usually 0.1 to 5 parts by mass, preferably 0.3 to 3 parts by mass based on 100 parts by mass of the rubber-based elastomer.

An organic solvent suitably selected from publicly known solvents having a good solubility to the rubber-based elastomer can be used as the organic solvent used for preparing the release agent solution. The above organic solvent includes, for example, toluene, xylene, methanol, ethanol, isobutanol, n-butanol, acetone, methyl ethyl ketone, tetrahydrofuran and the like. They may be used alone or in combination of two or more kinds thereof.

The release agent solution is preferably prepared so that a concentration of the solid matters falls in a range of 0.1 to 10% by mass, more preferably 0.5 to 5% by mass in terms of easiness in coating by using the above organic solvents.

In respect to a coating amount of the release agent solution, it is coated so that a thickness of the layer falls in a range of preferably 0.01 μm or more in order to obtain the required releasing force (light releasing), and it falls in a range of preferably 1 μm or less, particularly preferably 0.02 to 0.8 μm in order to prevent blocking from being caused.

The pressure sensitive adhesive solution can be coated on the base material film described above by a coating method which has so far been publicly known, such as a bar coating method, a reverse roll coating method, a knife coating method, a roll knife coating method, a gravure coating method, an air doctor coating method, a doctor blade coating method and the like.

In the present invention, an antioxidant may be added to the release agent layer.

The antioxidant is not specifically restricted, and capable of being used is any one of various publicly known phosphite-based antioxidants, organic sulfur-based antioxidants, hindered phenol-based antioxidants and the like which have been explained in the release agent layer.

The above antioxidants may be used alone or in combination of two or more kinds thereof. A use amount thereof is preferably 0.01 part by mass or more based on 100 parts by mass of the rubber-based elastomer from the viewpoint of inhibiting heavy release caused by degradation of the rubber-based elastomer, and it is preferably 10 parts by mass or less based on 100 parts by mass of the rubber-based elastomer from the viewpoint of sufficiently maintaining a pressure sensitive adhesive property between the release agent layer and the release sheet base material. The amount falls in a range of more preferably 0.05 to 5 parts by mass based on 100 parts by mass of the rubber-based elastomer.

The release agent solution is prepared by dissolving the rubber-based elastomer, the antioxidant and other components (an antistatic agent, a photoinitiator, a photosensitizer, a plasticizer, a stabilizer and the like) blended if necessary in an organic solvent.

In the pressure sensitive adhesive sheet of the present invention, the pressure sensitive adhesive layer as well as the release agent layer are constituted from a material which does not substantially a silicone-based compound. As a result, a silicone-based compound is not discharged from the pressure sensitive adhesive sheet after the pressure sensitive adhesive sheet is stuck on the adherend. Accordingly, the pressure sensitive adhesive sheet is less liable to exert an adverse effect even if the adherend is a precision electronic device. No silicone-based compound contained in the pressure sensitive adhesive layer and the release agent layer means that an amount of the silicone-based compound is preferably 250 μg/m² or less, more preferably 50 μg/m² or less.

In the pressure sensitive adhesive sheet of the present invention, an undercoat layer can be interposed, if necessary, between the release sheet base material (the base material 1 in the case of the pressure sensitive adhesive sheet B shown in FIG. 2) and the release agent layer. Interposing the undercoat layer provides the advantage that adhesion and the stable releasing force can be obtained. A material for forming the undercoat layer includes elastomers (hereinafter the undercoat layer is referred to as “the elastomer layer”).

Capable of being used as the elastomer are elastomers formed from materials including natural resins such as natural rubbers and the like, synthetic resins such as polyurethane-based resins, ethylene vinyl acetate copolymers, polyolefin-based resins and the like and synthetic rubbers, for example, a styrene butadiene-based, chloroprene-based, butyl-based, ethylene propylene-based and acrylic-based resins, and a polyurethane-based synthetic resins such as polyurethane elastomers, modified polyurethane elastomers and the like are particularly preferred since they have a solvent resistance (insoluble) to the organic solvent used in the release agent solution and an excellent rubber elasticity.

The elastomer layer can be formed by dissolving the material described above in an organic solvent to prepare an undercoat solution and coating it on the release sheet base material and drying. Further, the solvent resistance and the pressure sensitive adhesive property to the base material can be enhanced by irradiating, if necessary, with an ultraviolet ray after coated and dried.

In the case that the undercoat layer is provided, an antioxidant, a photosensitizer and the like can be blended, if necessary, therewith.

A solvent suitably selected from publicly known solvents having a good solubility to a material for forming the undercoat layer can be used as the organic solvent used for preparing the undercoat solution. The above organic solvent includes, for example, toluene, xylene, methanol, ethanol, isobutanol, n-butanol, acetone, methyl ethyl ketone, tetrahydrofuran and the like. Those may be used alone or in combination of two or more kinds thereof.

The undercoat solution is preferably prepared so that a concentration of the solid matters falls in a range of 0.1 to 15% by mass, more preferably 0.5 to 5% by mass in terms of easiness in coating by using the above organic solvents.

The undercoat solution can be coated on the release sheet base material (or the base material) described above by a coating method which has so far been publicly known, such as a bar coating method, a reverse roll coating method, a knife coating method, a roll knife coating method, a gravure coating method, an air doctor coating method, a doctor blade coating method and the like.

The undercoat solution is coated on the release sheet base material described above and dried by heating at a temperature of 40 to 160° C. for a time of 30 seconds to 2 minutes, whereby the undercoat layer can be formed.

In respect to an coating amount of the undercoat solution, it is coated so that a thickness of the layer falls in a range of preferably 0.01 μm or more in order to obtain the releasing stability after ageing which is an effect brought about by providing the undercoat layer, and it falls in a range of preferably 5 μm or less, particularly preferably 0.1 to 1 μm in terms of a thickness which does not cause blocking and is economical and efficient.

### EXAMPLES

Hereinafter, the present invention is more specifically explained with reference to examples, but it is a matter of fact that the present invention is not restricted by the examples.

### <Evaluation Methods and Test Methods>

### (1) Releasing Strength

### a) Releasing Force in Ordinary State:

After preparing pressure sensitive adhesive sheets, those were left standing for 7 days on the conditions of a temperature of 23° C. and a relative humidity of 50%, and then the respective releasing forces were measured on the same conditions.

The measurement was carried out by means of a universal tensile test equipment (model number: TENSILON UTM-4-100, manufactured by Orientec Co., Ltd.) on the conditions of a temperature of 23° C. and a relative humidity of 50%, wherein a release sheet side of the pressure sensitive adhesive tape (length: 150 mm, width: 20 mm) was stuck on a stainless steel plate by means of a double-faced pressure sensitive adhesive tape, and a base material side was stripped off in a 180° direction at a speed of 300 mm/minute.

b) Releasing Force after Thermal Acceleration:

After preparing pressure sensitive adhesive sheets, those were left standing for 7 days on the conditions of a temperature of 23° C. and a relative humidity of 50%, and after further left standing for 7 days on the condition of a temperature of 70° C. (dry), they were left standing for one day on the conditions of a temperature of 23° C. and a relative humidity of 50%, followed by measuring the respective releasing forces. Those were measured by the same method as in a).

### (2) Silicon Amount

After preparing a pressure sensitive adhesive sheet, it was left standing for 7 days on the conditions of a temperature of 23° C. and a relative humidity of 50%, and then the pressure sensitive adhesive sheet was cut in a size of 3 mm×3 mm to strip off the release sheet. Thereafter, a silicon amount on the pressure sensitive adhesive layer surface was measured by an X ray photoelectron spectroscopy (XPS) on the following conditions:

Measuring apparatus: Quantera SXM, manufactured by ULVAC-PHI, Inc.

X ray source: monochromatic AIKα (100 W, 20 KV)

Discharge angle: 45 degree

Measured elements: silicon (Si) and carbon (C)

The Si amount was obtained by multiplying a numerical value of Si/(Si+C) by 100 and shown by “%”.

### Example 1

A polyethylene terephthalate film (trade name “T100”, manufactured by Mitsubishi Polyester Film, Inc.) having a thickness of 38 μm was prepared as a release sheet base material, and an undercoat solution was coated on one surface thereof so that a thickness after dried was 0.15 μm and dried by heating at 100° C. for one minute to form an undercoat layer. The undercoat solution was prepared by diluting 100 parts by mass of a polyurethane solution (trade name “Crisvon 5150S”, solid matter concentration: 50% by mass, manufactured by Dainippon Ink & Chemicals, Inc.) and 5 parts by mass of an isocyanate-based cross-linking agent (trade name “Crisvon NX”, solid matter concentration: 30% by mass, manufactured by Dainippon Ink & Chemicals, Inc.) with methyl ethyl ketone so that a solid matter concentration was 1% by mass.

Subsequently, in order to form a release agent layer, 100 parts by mass of 1,4-polybutadiene (trade name “BR-01”, solid matter concentration: 5% by mass, manufactured by JSR Corporation) and 1 part by mass of an antioxidant (trade name “Irganox HP2251”, manufactured by Ciba Specialty Chemicals K.K.) were added and diluted with toluene so that a solid matter concentration was 0.5% by mass to prepare a release agent solution. The release agent solution was coated on the undercoat layer described above so that a thickness after dried was 0.1 μm and dried by heating at 100° C. for 30 seconds to form a release agent layer.

Subsequently, the release agent layer was irradiated with an ultraviolet ray by means of a belt conveyor type ultraviolet ray irradiation apparatus equipped with a fusion H valve 240 W/cm on the condition of a conveyor speed of 40 m/minute (ultraviolet ray irradiation condition: 100 mJ/cm²) and crosslinked to obtain a release sheet having the undercoat layer and the release agent layer on one surface of the release sheet base material.

Separately, a reactor equipped with a thermometer, a stirrer, a reflux condenser and a nitrogen gas introducing tube was charged with 70 parts by mass of 2-ethylhexyl acrylate, 28 parts by mass of vinyl acetate, 2 parts by mass of acrylic acid, 100 parts by mass of ethyl acetate and 0.5 part by mass of azobisisobutyronitrile as a polymerization initiator, and copolymerization reaction was carried out at 80° C. for 8 hours to obtain a pressure sensitive adhesive solution containing an acrylic-based resin having a weight average molecular weight of 800,000. An aluminum chelate cross-linking agent (trade name “BXX4805”, solid matter concentration: 5% by mass, manufactured by Toyo Ink Mfg. Co., Ltd.) 1.5 part by mass and a phosphite-based antioxidant (trade name “Irgafos 168”, manufactured by Ciba Specialty Chemicals K.K.) 0.1 part by mass as an antioxidant were added to 100 parts by mass of a resin component contained in the above pressure sensitive adhesive solution to prepare a pressure sensitive adhesive solution composition.

The pressure sensitive adhesive solution composition described above was coated on a release agent layer surface of the release sheet so that a thickness after dried was 25 μm and dried by heating at 120° C. for one minute to form a pressure sensitive adhesive layer. Then, the surfaces of a polyethylene terephthalate film (trade name “Lumirror #50T60”, manufactured by Toray Industries, Inc.) having a thickness of 50 μm and the pressure sensitive adhesive layer described above were stuck together, and a roller was reciprocated thereon once under applying a load of 19.6 N to prepare a pressure sensitive adhesive sheet.

### Example 2

A pressure sensitive adhesive sheet was prepared in the same manner as in Example 1, except that the pressure sensitive adhesive solution composition was changed to one having the following composition.

The phosphite-based antioxidant (trade name “Irgafos 168”, manufactured by Ciba Specialty Chemicals K.K.) 0.1 part by mass was added as an antioxidant to 100 parts by mass of solid matters contained in an acrylic-based copolymer solution composition comprising a mixture obtained by adding 1.0 part by mass of an isocyanate-based cross-linking agent (trade name “Colonate L”, solid matter concentration: 75% by mass, manufactured by Nippon Polyurethane Industry Co., Ltd.) to 100 parts by mass of an acrylic-based copolymer composition solution (trade name “AS665”, solid matter concentration: 40% by mass, manufactured by Ipposha oil Industries Co., Ltd.) to prepare a pressure sensitive adhesive solution composition.

### Example 3

A pressure sensitive adhesive sheet was prepared in the same manner as in Example 2, except that an addition amount of the phosphite-based antioxidant (trade name “Irgafos 168”, manufactured by Ciba Specialty Chemicals K.K.) was changed to 1.0 part by mass.

### Example 4

A pressure sensitive adhesive sheet was prepared in the same manner as in Example 2, except that the antioxidant was changed from the phosphite-based antioxidant (trade name “Irgafos 168”, manufactured by Ciba Specialty Chemicals K.K.) to a hindered phenol-based antioxidant (trade name “Irganox 1010”, manufactured by Ciba Specialty Chemicals K.K.) and that an addition amount thereof was changed to 0.1 part by mass.

### Example 5

A pressure sensitive adhesive sheet was prepared in the same manner as in Example 1, except that the pressure sensitive adhesive was changed to a product obtained by the following production process.

A reactor equipped with a thermometer, a stirrer, a reflux condenser and a nitrogen gas introducing tube was charged with 69 parts by mass of 2-ethylhexyl acrylate, 30 parts by mass of methyl acrylate, 1 part by mass of acrylic acid and 100 parts by mass of ethyl acetate, and copolymerization reaction was carried out at 80° C. for 8 hours under the presence of azobisisobutyronitrile as a polymerization initiator to obtain a pressure sensitive adhesive solution containing an acrylic-based resin having a weight average molecular weight of 700,000. The isocyanate-based cross-linking agent (trade name “Colonate L”, solid matter concentration: 75% by mass, manufactured by Nippon Polyurethane Industry Co., Ltd.) 1.0 part by mass and the phosphite-based antioxidant (trade name “Irgafos 168”, manufactured by Ciba Specialty Chemicals K.K.) 0.5 part by mass as an antioxidant were added to 100 parts by mass of a resin component contained in the above pressure sensitive adhesive solution to prepare a pressure sensitive adhesive solution composition.

### Example 6

A pressure sensitive adhesive sheet was prepared in the same manner as in Example 5, except that an addition amount of the phosphite-based antioxidant (trade name “Irgafos 168”, manufactured by Ciba Specialty Chemicals K.K.) was changed to 1.0 part by mass.

### Example 7

A pressure sensitive adhesive sheet was prepared in the same manner as in Example 5, except that the antioxidant was changed from the phosphite-based antioxidant (trade name “Irgafos 168”, manufactured by Ciba Specialty Chemicals K.K.) to a vitamin E-based antioxidant (“Irganox E201”, manufactured by Ciba Specialty Chemicals K.K.) and that an addition amount thereof was changed to 0.1 part by mass.

### Example 8

A pressure sensitive adhesive sheet was prepared in the same manner as in Example 1, except that the release sheet was changed to a product obtained by the following production process.

The polyethylene terephthalate film (“T100”, manufactured by Mitsubishi Plastics, Inc.) having a thickness of 38 μm was prepared as a release sheet base material, and an undercoat solution was coated on one surface thereof so that a thickness after dried was 0.15 μm and dried by heating at 100° C. for 1 minute to form an undercoat layer. The undercoat solution was prepared by diluting 100 parts by mass of the polyurethane solution (“Crisvon 5150S”, solid matter concentration: 50% by mass, manufactured by Dainippon Ink & Chemicals, Inc.) and 5 parts by mass of the isocyanate-based cross-linking agent (“Crisvon NX”, solid matter concentration: 30% by mass, manufactured by Dainippon Ink & Chemicals, Inc.) with methyl ethyl ketone so that a solid matter concentration was 1% by mass.

Subsequently, in order to form a release agent layer, 100 parts by mass of a polyisoprene rubber (“IR-2200”, solid matter concentration: 5% by mass, manufactured by JSR Corporation) and 0.1 part by mass of the antioxidant (“Irganox HP2251”, manufactured by Ciba Specialty Chemicals K.K.) were added and diluted with toluene so that a solid matter concentration was 0.5% by mass to prepare a release agent solution. The release agent solution was coated on the undercoat layer described above so that a thickness after dried was 0.1 μm and dried by heating at 100° C. for 30 seconds to form a release agent layer.

Subsequently, the coated layer was irradiated with an ultraviolet ray by means of a belt conveyor type ultraviolet ray irradiation apparatus equipped with a fusion H valve 240 W/cm on the condition of a conveyor speed of 40 m/minute (ultraviolet ray irradiation condition: 100 mJ/cm²) and crosslinked to obtain a release sheet having the undercoat layer and the release agent layer on one surface of the release sheet base material.

### Example 9

A pressure sensitive adhesive sheet was prepared in the same manner as in Example 8, except that an addition amount of the phosphite-based antioxidant (trade name “Irgafos 168”, manufactured by Ciba Specialty Chemicals K.K.) was changed to 1.0 part by mass.

### Example 10

A pressure sensitive adhesive sheet was prepared in the same manner as in Example 8, except that the antioxidant was changed from the phosphite-based antioxidant (trade name “Irgafos 168”, manufactured by Ciba Specialty Chemicals K.K.) to the vitamin E-based antioxidant (“Irganox E201”, manufactured by Ciba Specialty Chemicals K.K.) and that an addition amount thereof was changed to 0.1 part by mass.

### Example 11

A pressure sensitive adhesive sheet was prepared in the same manner as in Example 1, except that the release sheet was changed to a product obtained by the following production process.

The polyethylene terephthalate film (“T100”, manufactured by Mitsubishi Plastics, Inc.) having a thickness of 38 μm was prepared as a release sheet base material, and an undercoat solution was coated on one surface thereof so that a thickness after dried was 0.15 μm and dried by heating at 100° C. for one minute to form an undercoat layer. The undercoat solution was prepared by diluting 100 parts by mass of the polyurethane solution (“Crisvon 5150S”, solid matter concentration: 50% by mass, manufactured by Dainippon Ink & Chemicals, Inc.) and 5 parts by mass of the isocyanate-based cross-linking agent (“Crisvon NX”, solid matter concentration: 30% by mass, manufactured by Dainippon Ink & Chemicals, Inc.) with methyl ethyl ketone so that a solid matter concentration was 1% by mass.

Subsequently, in order to form a release agent layer, 100 parts by mass of a styrene-butadiene copolymer (“SL552”, solid matter concentration: 10% by mass, manufactured by JSR Corporation), 1 part by mass of the antioxidant (“Irganox HP2251”, manufactured by Ciba Specialty Chemicals K.K.) and 1 part by mass of a photoinitiator (“Irgacure 184”, manufactured by Ciba Specialty Chemicals K.K.) were added and diluted to a solid matter concentration of 0.5% by mass with toluene to prepare a release agent solution. The release agent solution was coated on the undercoat layer described above so that a thickness after dried was 0.1 μm and dried by heating at 100° C. for 30 seconds to form a release agent layer.

Subsequently, the coated layer was irradiated with an ultraviolet ray by means of a belt conveyor type ultraviolet ray irradiation apparatus equipped with a fusion H valve 240 W/cm on the condition of a conveyor speed of 40 m/minute (ultraviolet ray irradiation condition: 100 mJ/cm²) and crosslinked to obtain a release sheet having the undercoat layer and the release agent layer on one surface of the base material.

### Example 12

A pressure sensitive adhesive sheet was prepared in the same manner as in Example 1, except that the release sheet was changed to a product obtained by the following production process.

The polyethylene terephthalate film (“T100”, manufactured by Mitsubishi Plastics, Inc.) having a thickness of 38 μm was prepared as a release sheet base material, and an undercoat solution was coated on one surface thereof so that a thickness after dried was 0.15 μm and dried by heating at 100° C. for 1 minute to form an undercoat layer.

The undercoat solution was prepared by diluting 100 parts by mass of the polyurethane solution (“Crisvon 5150S”, solid matter concentration: 50% by mass, manufactured by Dainippon Ink & Chemicals, Inc.) and 5 parts by mass of the isocyanate-based cross-linking agent (“Crisvon NX”, solid matter concentration: 30% by mass, manufactured by Dainippon Ink & Chemicals, Inc.) with methyl ethyl ketone so that a solid matter concentration was 1% by mass.

Subsequently, in order to form a release agent layer, 100 parts by mass of EPDM (“EP43”, solid matter concentration: 5% by mass, manufactured by JSR Corporation), 1 part by mass of the antioxidant (“Irganox HP2251”, manufactured by Ciba Specialty Chemicals K.K.) and 1 part by mass of the photoinitiator (“Irgacure 184”, manufactured by Ciba Specialty Chemicals K.K.) were added and diluted with toluene so that a solid matter concentration was 0.5% by mass to prepare a release agent solution. The release agent solution was coated on the undercoat layer described above so that a thickness after dried was 0.1 μm and dried by heating at 100° C. for 30 seconds to form a release agent layer.

Subsequently, the coated layer was irradiated with an ultraviolet ray by means of a belt conveyor type ultraviolet ray irradiation apparatus equipped with a fusion H valve 240 W/cm on the condition of a conveyor speed of 40 m/minute (ultraviolet ray irradiation condition: 100 mJ/cm²) and crosslinked to obtain a release sheet having the undercoat layer and the release agent layer on one surface of the release sheet base material.

### Comparative Example 1

A pressure sensitive adhesive sheet was prepared in the same manner as in Example 1, except that the phosphite-based antioxidant (trade name “Irgafos 168”, manufactured by Ciba Specialty Chemicals K.K.) was not added to the pressure sensitive adhesive solution.

### Comparative Example 2

A pressure sensitive adhesive sheet was prepared in the same manner as in Example 2, except that the phosphite-based antioxidant (trade name “Irgafos 168”, manufactured by Ciba Specialty Chemicals K.K.) was not added to the pressure sensitive adhesive solution.

### Comparative Example 3

A pressure sensitive adhesive sheet was prepared in the same manner as in Example 2, except that a release agent solution prepared by diluting 100 parts by mass of a silicone-based release agent (trade name “KS-847H”, solid matter concentration: 30% by mass, manufactured by Shin-Etsu Chemical Co., Ltd.) and 1 part by mass of a curing catalyst (trade name “CAT-PL-50T”, solid matter concentration: 2% by mass, manufactured by Shin-Etsu Chemical Co., Ltd.) with toluene so that a solid matter concentration was 1% by mass was coated so that a thickness after dried was 0.1 μm and dried by heating at 100° C. for 30 seconds to obtain a release sheet and that the above release sheet was used.

### Comparative Example 4

A pressure sensitive adhesive sheet was prepared in the same manner as in Example 5, except that the phosphite-based antioxidant (trade name “Irgafos 168”, manufactured by Ciba Specialty Chemicals K.K.) was not added.

### Comparative Example 5

A pressure sensitive adhesive sheet was prepared in the same manner as in Example 2, except that the phosphite-based antioxidant (“Irganox HP2251”, manufactured by Ciba Specialty Chemicals K.K.) was not added.

### Comparative Example 6

A pressure sensitive adhesive sheet was prepared in the same manner as in Example 11, except that the phosphite-based antioxidant (“Irganox HP2251”, manufactured by Ciba Specialty Chemicals K.K.) was not added.

### Comparative Example 7

A pressure sensitive adhesive sheet was prepared in the same manner as in Example 12, except that the phosphite-based antioxidant (“Irganox HP2251”, manufactured by Ciba Specialty Chemicals K.K.) was not added.

The pressure sensitive adhesive sheets obtained in Examples 1 to 12 and Comparative Examples 1 to 7 were used to carry out the tests of the items described above. The results thereof are shown together in Table 1.

TABLE 1

| | Releasing force (mN/20 mm) | | | |
|---|---|---|---|---|
| | Releasing force | Releasing force | | |
| | A in ordinary | B after thermal | | XPS |
| | state | acceleration | B/A | measurement (%) |
| Example 1 | 86 | 202 | 2.35 | 0 |
| Example 2 | 152 | 852 | 5.61 | 0 |
| Example 3 | 166 | 521 | 3.14 | 0 |
| Example 4 | 150 | 735 | 4.9 | 0 |
| Example 5 | 86 | 127 | 1.47 | 0 |
| Example 6 | 89 | 137 | 1.53 | 0 |
| Example 7 | 91 | 181 | 2.00 | 0 |
| Example 8 | 213 | 623 | 2.92 | 0 |
| Example 9 | 209 | 561 | 2.68 | 0 |
| Example 10 | 230 | 635 | 2.76 | 0 |
| Example 11 | 1021 | 2221 | 2.18 | 0 |
| Example 12 | 2031 | 4310 | 2.12 | 0 |
| Comparative | 115 | 2800 | 24.35 | 0 |
| Example 1 | | | | |
| Comparative | 137 | 2300 | 16.79 | 0 |
| Example 2 | | | | |
| Comparative | 57 | 50 | 0.88 | 24 |
| Example 3 | | | | |
| Comparative | 261 | 4300 | 16.48 | 0 |
| Example 4 | | | | |
| Comparative | 512 | 8034 | 15.69 | 0 |
| Example 5 | | | | |
| Comparative | 1812 | Impossible to | — | 0 |
| Example 6 | | measure | | |
| Comparative | 3121 | Impossible to | — | 0 |
| Example 7 | | measure | | |

### INDUSTRIAL APPLICABILITY

In the pressure sensitive adhesive sheet of the present invention, a pressure sensitive adhesive and a release agent of a non silicone-based release agent are used, and therefore it is a pressure sensitive adhesive sheet which does not exert an adverse effect on electronic parts when it is used in the electronic part field and has a good releasing property between a pressure sensitive adhesive layer and a release agent layer even after subjected to thermal history, that is, which does not bring about heavy releasing and is excellent in a releasing stability. It is suitably used for applications related to electronic parts loaded in printed wiring boards and precision electronic devices such as magnetic recording devices (HDD) and the like.

1. A pressure sensitive adhesive sheet comprising a pressure sensitive adhesive layer formed on at least one surface of a base material, wherein a side opposite of a surface of the above pressure sensitive adhesive layer is in contact with a release agent layer, wherein the pressure sensitive adhesive layer and the release agent layer do not substantially comprise a silicone compound, and the pressure sensitive adhesive layer comprises an antioxidant.

2. The pressure sensitive adhesive sheet according to claim 1, wherein the release agent layer comprises a rubber elastomer.

3. The pressure sensitive adhesive sheet according to claim 2, wherein the rubber elastomer is at least one selected from the group consisting of diene homopolymer, diene copolymer and ethylene propylene copolymer.

4. The pressure sensitive adhesive sheet according to claim 3, wherein the diene homopolymer is a polybutadiene rubber or a polyisoprene rubber.

5. The pressure sensitive adhesive sheet according to claim 3, wherein the diene copolymer is a styrene-butadiene copolymer.

6. The pressure sensitive adhesive sheet according to claim 4, wherein the polybutadiene rubber is 1,4-polybutadiene.

7. The pressure sensitive adhesive sheet according to claim 1, wherein the pressure sensitive adhesive layer comprises an acrylic pressure sensitive adhesive.

8. The pressure sensitive adhesive sheet according to claim 1, wherein the release agent layer is formed on at least one surface of a base material for release sheet.

9. The pressure sensitive adhesive sheet according to claim 1, wherein an undercoat layer is present between the base material and the release agent layer or between the base material for release sheet and the release agent layer.

10. The pressure sensitive adhesive sheet according to claim 9, wherein the undercoat layer comprises a polyurethane elastomer.

11. The pressure sensitive adhesive sheet according to claim 1, wherein the release agent layer comprises an antioxidant.

12. The pressure sensitive adhesive sheet according to claim 1, wherein the release agent layer is crosslinked by irradiating with an ultraviolet ray.

13. The pressure sensitive adhesive sheet according to claim 1, wherein the pressure sensitive adhesive layer and the release agent layer do not comprise a silicon compound.
